(19) United States
(12) Patent Application Publication
(10) Pub. No.: US 2026/0279671 A1
(43) Pub. Date: Sep. 17, 2026

(54) MULTILAYER CERAMIC CAPACITOR

(71) Applicant: Murata Manufacturing Co., Ltd., Nagaokakyo-shi (JP)

(72) Inventor: Shinichi HIKIDA, Nagaokakyo-shi (JP)

(21) Appl. No.: 19/683,815

(22) Filed: May 21, 2026

Related U.S. Application Data
(63) Continuation of application No. PCT/JP2024/017210, filed on May 9, 2024.

(30) Foreign Application Priority Data
Nov. 27, 2023 (JP) 2023-199699

(51) Int. Cl. H01G 4/224; H01G 4/12; H01G 4/232; H01G 4/248; H01G 4/30

(52) U.S. Cl. CPC H01G 4/224; H01G 4/12; H01G 4/232; H01G 4/248; H01G 4/30

(57) ABSTRACT

A multilayer ceramic capacitor includes a multilayer body including six surfaces, a first outer electrode, and a second outer electrode. The multilayer body includes an inner-layer portion and two outer-layer portions sandwiching the inner-layer portion in a lamination direction. Each outer-layer portion includes an outer dielectric layer, and the outer dielectric layer includes fibers.

### CROSS REFERENCE TO RELATED APPLICATIONS

This application claims the benefit of priority to Japanese Patent Application No. 2023-199699 filed on Nov. 27, 2023 and is a Continuation Application of PCT Application No. PCT/JP2024/017210 filed on May 9, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, electronic devices, such as mobile phones and portable music players, have been subjected to size and thickness reduction. Multilayer ceramic electronic components included in an electronic device are also subjected to size and thickness reduction. These multilayer ceramic electronic components are often embedded in a circuit board of the electronic device or mounted on the surface thereof. Japanese Unexamined Patent Application Publication No. 2022-166463 describes an example of a multilayer ceramic capacitor of which an outer dimension T is 100 μm or less (T≤100 μm), the outer dimension T being a dimension in the direction normal to the first end surface and normal to the first inner electrode. The size and thickness reduction of the multilayer ceramic capacitor has brought up an issue of how to secure the strength of the multilayer ceramic capacitor.

### SUMMARY OF THE INVENTION

Example embodiments of the present invention provide multilayer ceramic capacitors that each achieve increased strength.

According to an example embodiment of the present invention, a multilayer ceramic capacitor includes a multilayer body including a first surface and a second surface that face oppositely in a lamination direction, a third surface and a fourth surface that face oppositely in a first direction that orthogonally intersects the lamination direction, and a fifth surface and a sixth surface that face oppositely in a second direction that orthogonally intersects the lamination direction and the first direction. The multilayer ceramic capacitor also includes a first outer electrode on the third surface of the multilayer body and a second outer electrode on the fourth surface of the multilayer body. The multilayer body includes an inner-layer portion and two outer-layer portions sandwiching the inner-layer portion in the lamination direction. Each of the two outer-layer portions includes an outer dielectric layer that includes fibers.

According to example embodiments of the present invention, multilayer ceramic capacitors with increased strength are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a multilayer ceramic capacitor according to an example embodiment of the present invention.

FIG. 2 is a cross-sectional view taken along line 201-201 in FIG. 1.

FIG. 3 is a cross-sectional view taken along line 202-202 in FIG. 1.

FIG. 4 is a view corresponding to the cross-sectional view taken along line 201-201 in FIG. 1.

FIG. 5 is another view corresponding to the cross-sectional view taken along line 201-201 in FIG. 1.

FIG. 6 is a perspective view illustrating another example of the multilayer ceramic capacitor of the present example embodiment of the present invention.

FIG. 7 is a perspective view illustrating another example of the multilayer ceramic capacitor of the present example embodiment of the present invention.

FIG. 8 is a perspective view illustrating another example of the multilayer ceramic capacitor of the present example embodiment of the present invention.

FIG. 9 is a perspective view illustrating another example of the multilayer ceramic capacitor of the present example embodiment of the present invention.

### DETAILED DESCRIPTION OF THE EXAMPLE EMBODIMENTS

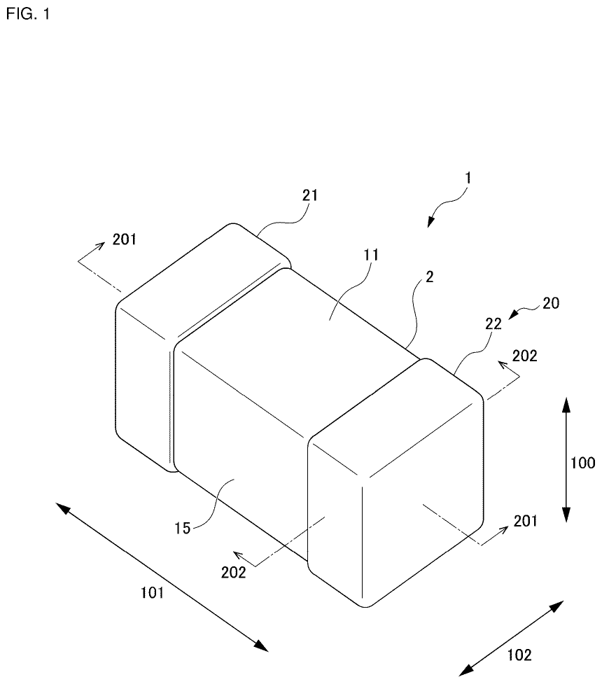

A multilayer ceramic capacitor 1 is outlined with reference to FIG. 1. FIG. 1 is a perspective view illustrating the multilayer ceramic capacitor 1 according to an example embodiment. The multilayer ceramic capacitor 1 includes a multilayer body 2 and outer electrodes 20. The outer electrodes 20 include a first outer electrode 21 and a second outer electrode 22.

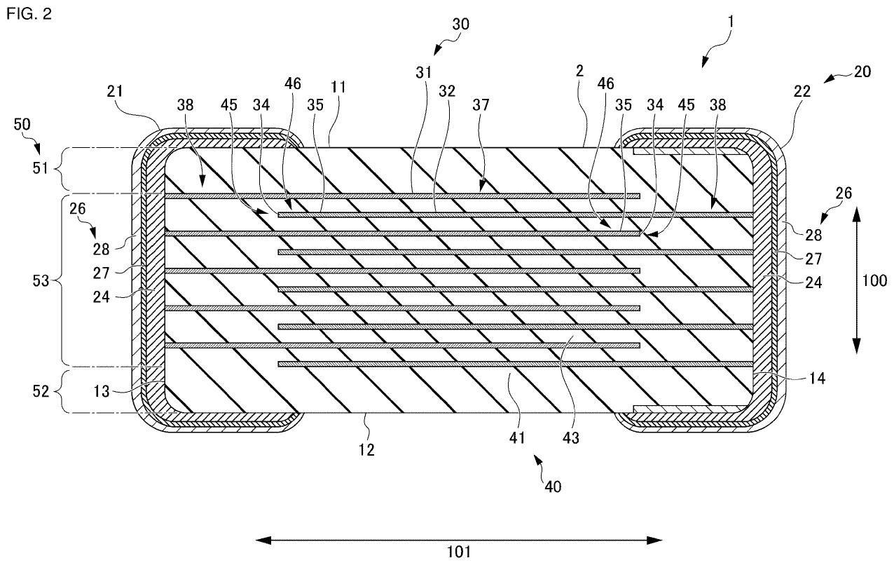

The internal structure of the multilayer body 2 is described with reference to FIG. 2. FIG. 2 is a cross-sectional view taken along line 201-201 in FIG. 1. The multilayer body 2 includes multiple inner electrodes 30 and multiple dielectric layers 40, and these are laminated. A direction in which the inner electrodes 30 and the dielectric layers 40 are laminated is referred to as a lamination direction 100.

As illustrated in FIG. 1, the multilayer body 2 is shaped like a cuboid. The surfaces of the multilayer body 2 are referred to in the following manner. Two surfaces facing opposite to each other in the lamination direction 100 are referred to as a first surface 11 and a second surface 12, respectively. Two surfaces facing opposite to each other in a first direction 101, which is a direction orthogonal to the lamination direction 100, are referred to as a third surface 13 and a fourth surface 14, respectively. Two surfaces facing opposite to each other in a second direction 102, which is a direction orthogonal to both the first direction 101 and the lamination direction 100, are referred to as a fifth surface 15 and a sixth surface 16, respectively.

Both of, or any one of, the first surface 11 and the second surface 12 is preferably flat.

When the multilayer ceramic capacitor 1 is picked up using a pick-up nozzle, the multilayer ceramic capacitor 1 receives stresses from the nozzle. The flat surface of the multilayer body serves to disperse the stresses. The surface of the multilayer body 2 may be roughened.

The multilayer body 2 includes edges at which two of the first surface 11, the second surface 12, the third surface 13, the fourth surface 14, the fifth surface 15, and the sixth surface 16 meet. The multilayer body 2 includes corners at which three of the first surface 11, the second surface 12, the third surface 13, the fourth surface 14, the fifth surface 15, and the sixth surface 16 meet.

The edges and the corners are preferably rounded. The rounded edges and corners reduce or prevent the occurrence of chipping or breakage of the multilayer body 2.

When the edges and corners are rounded, the other portions of the surfaces of the multilayer body 2 may be flat.

As illustrated in FIG. 2, the multilayer body 2 includes an inner-layer portion 53 and outer-layer portions 50. The inner-layer portion 53 is a portion in which the inner electrodes 30 and the dielectric layers 40 are laminated. The outer-layer portions 50 are portions in which the dielectric layers 40 are laminated.

The outer-layer portions 50 include a first-surface-side outer-layer portion 51 and a second-surface-side outer-layer portion 52. The first-surface-side outer-layer portion 51 is one of the outer-layer portions 50 and is positioned between the inner-layer portion 53 and the first surface 11. The second-surface-side outer-layer portion 52 is the other outer-layer portion 50 and is positioned between the inner-layer portion 53 and the second surface 12. The inner-layer portion 53 is sandwiched in the lamination direction 100 between the outer-layer portions 50, in other words, the first-surface-side outer-layer portion 51 and the second-surface-side outer-layer portion 52.

The layer structures of the inner-layer portion 53 and the outer-layer portions 50 are described in the following paragraphs. The inner electrodes 30 include first inner electrodes 31 and second inner electrodes 32. The dielectric layers 40 include outer dielectric layers 41 and inner dielectric layers 43.

The inner-layer portion 53 includes the first inner electrodes 31, the second inner electrodes 32, and the inner dielectric layers 43. The first inner electrodes 31 are the inner electrodes 30 of which one ends are exposed on the third surface 13. The second inner electrodes 32 are the inner electrodes 30 of which one ends are exposed on the fourth surface 14. The inner dielectric layers 43 are the dielectric layers 40 that are laminated between the first inner electrodes 31 and the second inner electrodes 32 in an alternate manner.

Each inner dielectric layer 43 includes a first region 45 and a second region 46. In the first direction 101, each inner electrode 30 has one end that is not exposed at the third surface or the fourth surface, and the one end is referred to as an inner-electrode end 34. In each inner dielectric layer 43, the first region 45 covers the inner-electrode end 34.

Each inner electrode 30 has a surface facing in the lamination direction 100, and the surface is referred to as a lamination surface 35. In each inner dielectric layer 43, the second region 46 covers the lamination surface 35.

A dielectric component that the first region 45 includes at the highest content is preferably the same as a dielectric component that the second region 46 includes at the highest content. The type of the dielectric component is not specifically limited here.

When the dielectric component includes calcium titanate or calcium zirconate at a high content, the following effect can be obtained. The high content of calcium titanate or calcium zirconate can reduce the occurrence of dielectric breakdown between the second outer electrode 22 and the inner-electrode ends 34 of the first inner electrodes 31 and between the first outer electrode 21 and the inner-electrode ends 34 of the second inner electrodes 32 and also between the first inner electrodes 31 and the second inner electrodes 32.

The dielectric component is not limited to calcium titanate or calcium zirconate. The main ingredient of the dielectric component may be strontium titanate.

The main ingredient of the dielectric component may be barium titanate. The dielectric constant of barium titanate is high. In the case of the main ingredient of the dielectric component being barium titanate, the capacitance of the multilayer ceramic capacitor 1 becomes greater.

Each inner electrode 30 includes an opposing region 37 and an extension region 38. The opposing region 37 of the first inner electrode 31 opposes the opposing region 37 of the second inner electrode 32. The extension region 38 is a region extended from each opposing region 37 onto the third surface 13 or onto the fourth surface 14.

The width of the inner electrode 30 in the second direction 102 may change closer to the third surface 13 or to the fourth surface 14.

For example, the component of each inner electrode 30 may be a metal, such as nickel, copper, silver, palladium, and gold, or an alloy including at least one of these, such as silver-palladium alloy. The component of the inner electrode 30 is not specifically limited insofar as the component is an electroconductive material.

The inner electrode 30 may include tin. Inclusion of tin in the inner electrode 30 can alleviate the concentration of electric field at the interface between the inner electrode 30 and the dielectric layer 40. This improves the reliability of the multilayer ceramic capacitor 1 under a high-temperature load.

Tin may be included either in the first inner electrode 31 or in the second inner electrode 32. Inclusion of tin either in the first inner electrode 31 or in the second inner electrode 32 can alleviate the concentration of electric field and improve the reliability under a high-temperature load.

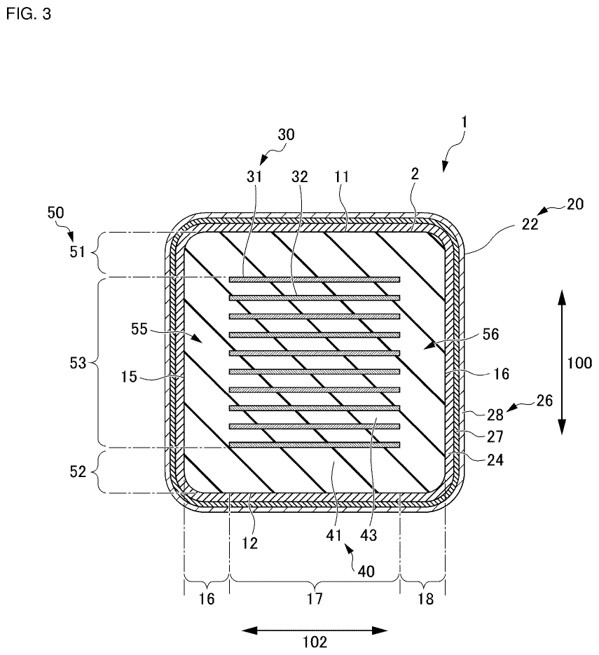

The structure of the multilayer body 2 in the second direction 102 is described with reference to FIG. 3. FIG. 3 is a cross-sectional view taken along line 202-202 in FIG. 1. A region between the fifth surface 15 and the first inner electrodes 31 and between the fifth surface 15 and the second inner electrodes 32 is referred to as a first widthwise region 55. A region between the sixth surface 16 and the first inner electrodes 31 and between the sixth surface 16 and the second inner electrodes 32 is referred to as a second widthwise region 56.

Silicon may be segregated between the inner electrodes 30 and the first widthwise region 55 or between the inner electrodes 30 and the second widthwise region 56. Segregated silicon increases the strength of the multilayer ceramic capacitor 1 against bending.

The first-surface-side outer-layer portion 51 and the second-surface-side outer-layer portion 52 are made of an insulating material. In the case of the first-surface-side outer-layer portion 51 and the second-surface-side outer-layer portion 52 being made of the same dielectric material of the inner dielectric layers 43, the first-surface-side outer-layer portion 51 and the second-surface-side outer-layer portion 52 may include multiple outer dielectric layers 41 or a single outer dielectric layer 41.

The inner dielectric layers 43 and the outer dielectric layers 41 may include different components. For example, the components of the inner dielectric layers 43 may be higher in dielectric constant than those of the outer dielectric layers 41.

The outer dielectric layers 41 may include components that are high in moisture resistance, weather resistance, and strength.

The outer electrodes 20 are described. As illustrated in FIG. 2, the outer electrodes 20 include the first outer electrode 21 and the second outer electrode 22. The first outer electrode 21 is an outer electrode 20 on the third surface 13. The second outer electrode 22 is an outer electrode 20 on the fourth surface 14.

The outer electrodes 20 may extend onto the first surface 11, the second surface 12, the fifth surface 15, and the sixth surface 16.

Each outer electrode 20 includes a base electrode layer 24 and a plating layer 26. The base electrode layer 24 is provided on the multilayer body 2 and the plating layer 26 is provided on the base electrode layer 24.

The base electrode layer 24 is preferably made of a metal, such as copper or nickel. In addition to the metal component, the base electrode layer 24 may also include the same dielectric component as the main component of the inner dielectric layers 43. In the case of the base electrode layer 24 including the same dielectric component as the main component of the inner dielectric layers 43, the difference in coefficient of thermal expansion is reduced between the multilayer body 2 and the base electrode layer 24. This can reduce stresses that may act in the base electrode layer 24.

The base electrode layer 24 may include metals other than the copper and nickel. Examples of other metals are magnesium, chromium, strontium, aluminum, sodium, and iron.

The base electrode layer 24 may also include glass in addition to the dielectric component. For example, the glass component may be an oxide of barium, strontium, silicon, calcium, zinc, aluminum, or boron.

A metal layer may be provided in place of the base electrode layer 24. The metal layer may be provided on both of, or any one of, the first surface 11 and the second surface 12.

In the case of the metal film being provided, a plated electrode may connect the metal film to the inner electrodes 30.

The metal film may be formed by sputtering or vapor deposition so that the thickness of the metal film can be reduced to about 1 μm or less, for example. This can reduce the size of the multilayer ceramic capacitor 1 in the lamination direction 100.

The plating layer 26 is described. The plating layer 26 is provided on the base electrode layer 24. The plating layer 26 preferably has a structure of at least two layers. The plating layer 26 includes, for example, a nickel-plating layer 27 and a tin-plating layer 28. FIGS. 2 and 3 illustrate an example of the plating layer 26 including the nickel-plating layer 27 and the tin-plating layer 28. The nickel-plating layer 27 is provided on the base electrode layer 24, and the tin-plating layer 28 is provided on the nickel-plating layer 27.

The nickel-plating layer 27 serves to prevent solder from eroding the base electrode layer 24. The tin-plating layer 28 serves to improve the mountability of the multilayer ceramic capacitor 1 onto a circuit board.

The plating layer 26 may include three or more layers. In the case of the plating layer 26 having a three-layer structure, a tin-plating layer, a nickel-plating layer, and another tin-plating layer may be provided in this order from the base electrode layer 24.

For example, the plating layer 26 preferably include at least one of metals including copper, nickel, tin, lead, gold, silver, palladium, bismuth, and zinc or preferably include an alloy including any one of these. It is preferable that the plating layer do not include glass. The metal content per unit volume of the plating layer is preferably about 99 vol % or more, for example.

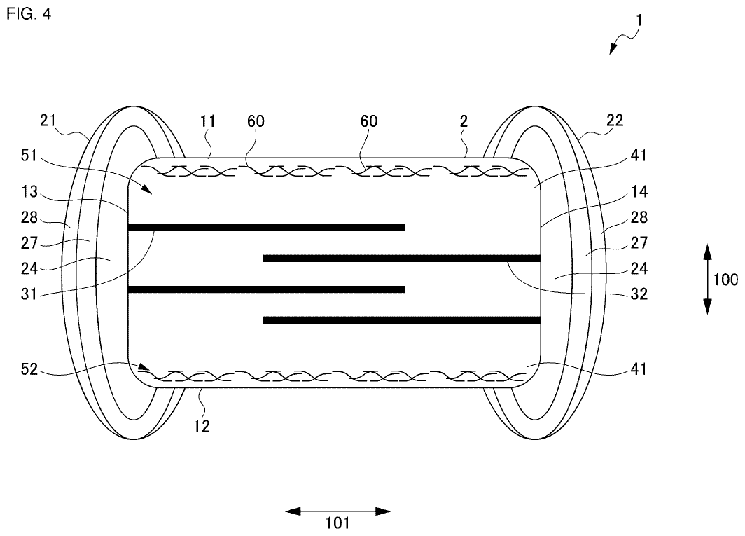

Fibers 60 are described with reference to FIG. 4. FIG. 4 is a view corresponding to the cross-sectional view taken along line 201-201 in FIG. 1. In the multilayer ceramic capacitor 1, the multilayer body 2 includes fibers 60. For example, the fibers 60 are carbon or silicon-carbide fibers, alumina fibers, or boron fibers.

The above expression “the multilayer body 2 includes fibers” means that the fibers 60 are present in any of, or only one of, the inner electrodes 30, the inner dielectric layers 43, and the outer dielectric layers 41.

In the example illustrated in FIG. 4, the first-surface-side outer-layer portion 51 and the second-surface-side outer-layer portion 52 include the fibers 60. Note that at least one of the first-surface-side outer-layer portion 51 and the second-surface-side outer-layer portion 52 may include the fibers 60.

Inclusion of the fibers 60 in the first-surface-side outer-layer portion 51 and the second-surface-side outer-layer portion 52 can increase the mechanical strength of the multilayer ceramic capacitor 1 without much affecting the dielectric constant and the electric resistance of the multilayer ceramic capacitor 1.

The fibers 60 are such that multiple fibers are entangled with each other. Entangled fibers 60 further increase the mechanical strength of the multilayer ceramic capacitor 1.

In the case of the first-surface-side outer-layer portion 51 and the second-surface-side outer-layer portion 52 being formed of multiple outer dielectric layers 41, the fibers 60 may be present in every outer dielectric layer 41. Alternatively, an outer dielectric layer 41 including the fibers 60 and an outer dielectric layer 41 having no fiber 60 may be laminated. In other words, an outer dielectric layer 41 including the fibers 60 and an outer dielectric layer 41 having no fiber 60 may be prepared separately, and these outer dielectric layers 41 may be laminated.

The outer dielectric layers 41 having no fiber 60 are provided to define the first surface 11 and the second surface 12. This can prevent the fibers 60 from being exposed at the surfaces of the multilayer body 2.

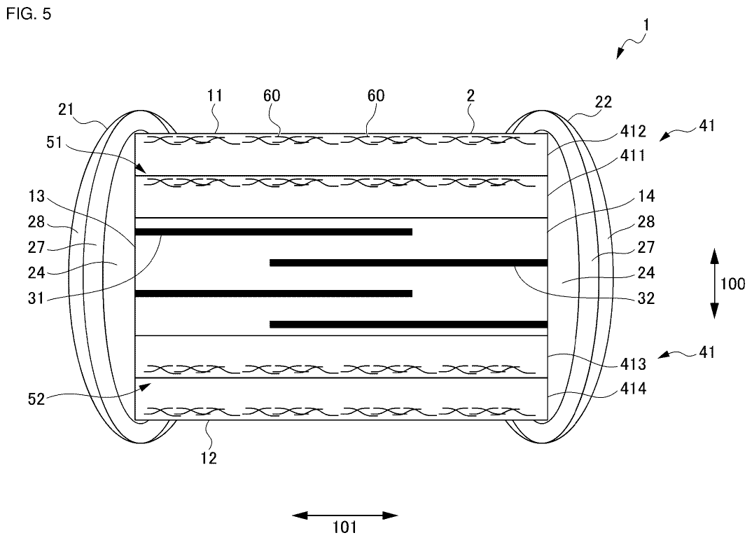

FIG. 5 is another view corresponding to the cross-sectional view taken along line 201-201 in FIG. 1. In the multilayer ceramic capacitor 1 illustrated in FIG. 4, the first-surface-side outer-layer portion 51 and the second-surface-side outer-layer portion 52 each include one outer dielectric layer 41. On the other hand, in the multilayer ceramic capacitor 1 illustrated in FIG. 5, the first-surface-side outer-layer portion 51 and the second-surface-side outer-layer portion 52 each include two outer dielectric layers 41.

As illustrated in FIG. 5, the first-surface-side outer-layer portion 51 includes two outer dielectric layers 41, in other words, an outer dielectric layer 411 and an outer dielectric layer 412. The second-surface-side outer-layer portion 52 includes two outer dielectric layers 41, in other words, an outer dielectric layer 413 and an outer dielectric layer 414.

In the example illustrated in FIG. 5, the outer dielectric layer 411, the outer dielectric layer 412, the outer dielectric layer 413, the outer dielectric layer 414 each include the fibers 60. Accordingly, multiple layers having entangled fibers 60 are provided in each of the first-surface-side outer-layer portion 51 and the second-surface-side outer-layer portion 52. As a result, the mechanical strength of the multilayer ceramic capacitor 1 is further increased.

If each fiber 60 is too thick or the size thereof is too large, the fibers 60 are difficult to be entangled with each other, resulting in scattered presence of the fibers 60. This does not contribute to the increase of the mechanical strength of the multilayer ceramic capacitor 1. This may cause clack generation inside the multilayer body 2 due to the difference in contraction between the fibers 60 and the dielectric component during sintering (to be described later).

If the aspect ratio of each fiber 60 (ratio of the length of the fiber 60 to the thickness of the fiber 60) is small, the fibers 60 are not entangled easily with each other, which does not increase the mechanical strength of the multilayer ceramic capacitor 1.

Accordingly, the length of each fiber 60 is preferably about 1μm or more and about 100μm or less, for example. If the length of each fiber 60 is too great, the fibers 60 are entangled too much, which causes the fibers 60 to coagulate easily. In addition, the thickness of each fiber 60 is preferably about 1 nm or more and about 1000 nm or less, for example. The number of intersections of the fibers 60 is preferably five or more in a region of approximately 2.5 μm×2.5 μm, for example. This facilitates the entanglement of the fibers 60 and increases the mechanical strength of the multilayer ceramic capacitor 1.

In order to obtain five or more intersections of the fibers 60 in the region of approximately 2.5 μm×2.5 μm, for example, the fibers 60 may include a desired amount of relatively long fibers. For example, the “relatively long fibers” included in the fibers 60 are fibers of which the length is, for example, about 1 μm or more and about 100 μm or less. For example, the “desired amount” above is such that five or more fibers 60 are present within a region of approximately 2.5 μm×2.5 μm of a sintered multilayer ceramic capacitor 1.

The thickness of each fiber 60 and the method of observing the thickness are described. The thickness of an individual fiber 60 can be determined as follows. For example, the multilayer ceramic capacitor 1 is ground to a half of its length in the second direction 102 to expose a cross section extending parallel to the lamination direction 100 and the first direction 101 of the multilayer ceramic capacitor 1.

Subsequently, the thicknesses of individual fibers 60 are observed using a scanning probe microscope with a field-of-view size of approximately 2.5 μm×2.5 μm within an area where ten or more fibers can be observed. More specifically, the thicknesses of individual fibers 60 are observed in an area observable with a field-of-view size of approximately 250 nm×250 nm or of approximately 2.5 μm×2.5 μm, for example.

In addition, the number of intersections of the fibers 60 can be determined by counting the intersections with a field-of-view size of approximately 2.5 μm×2.5 μm. In other words, individual fibers 60 are regarded as lines, and the number of intersections to be counted is the number of points at which lines of the fibers 60 intersect other lines of the fibers 60.

The content of the fibers 60 by percentage is described. The content of the fibers 60 is preferably about 1.0 wt % or more and about 30.0 wt % or less, for example. If the content of the fibers 60 is too high when, for example, electrically conductive carbon fibers are used, the carbon fibers may electrically connect the first outer electrode 21 and the second outer electrode 22, which increases the likelihood of the multilayer ceramic capacitor 1 failing to function as the capacitor. Moreover, if the content of the fibers 60 is too high, the fibers 60 become more difficult to adhere to other dielectric layers, which may cause structural defects to occur easily. Accordingly, it is more preferable that the content of the fibers 60 be about 1.0 wt % or more and about 30.0 wt % or less, for example. If the content of the fibers 60 is too low, the total amount of the fibers 60 becomes small, which makes it difficult to increase the mechanical strength.

The content of the fibers 60 can be determined by adjusting the amount of the fibers 60 added in the process of manufacturing the multilayer ceramic capacitor 1.

The content of the fibers 60 by percentage is defined and confirmed in the following manner. For example, the multilayer ceramic capacitor 1 is ground to a half of its length in the second direction 102 to expose a cross section extending parallel to the lamination direction 100 and the first direction 101 of the multilayer ceramic capacitor 1. The cross section obtained is divided in the first direction 101 equally into five divisions. Five regions positioned at respective centers of the five divisions are observed using a scanning probe microscope with a field-of-view size of approximately 2.5 μm×2.5 μm, for example. Each observation image is converted into a binary representation. The content of the fibers 60 is obtained by averaging the results for the five regions.

The dimensions of the multilayer ceramic capacitor 1 are described. The dimensions of the multilayer ceramic capacitor 1 including the outer electrodes 20 are not specifically limited. The smaller the dimension of the multilayer ceramic capacitor 1 in the lamination direction 100 is, the weaker the mechanical strength in the lamination direction 100. Accordingly, in the case of the dimension of the multilayer ceramic capacitor 1 being about 110 μm or less in the lamination direction 100, for example, the mechanical strength of the multilayer ceramic capacitor 1 in the lamination direction 100 can be increased by applying the structure of the present example embodiment.

Accordingly, the dimension of the multilayer ceramic capacitor 1 in the lamination direction 100 is preferably about 80 μm or less, more preferably about 60 μm or less, and even more preferably about 40 μm or less, for example. If the dimension is about 80 μm or less, for example, the mechanical strength in the lamination direction 100 becomes remarkably small, and the application of the structure of an example embodiment of the present invention becomes more advantageous.

A non-limiting example of a method of manufacturing the multilayer ceramic capacitor 1 is described.
In Step 1, a dielectric sheet for the inner dielectric layers 43 and an electroconductive paste for the inner electrodes 30 are prepared. The dielectric sheet and the electroconductive paste and dielectric sheet for the inner electrodes 30 include a binder and an organic solvent. Known materials can be used for the binder and the organic solvent.

A dielectric paste for the first region 45 of each inner dielectric layer 43 may be provided separately. For example, the dielectric material for the first region 45 and for the second region may be changed to calcium zirconate or barium titanate. The dielectric material is not limited to the above but may be any desirable material.

The fibers 60 may be added separately to the above material when necessary. The content of the fibers 60 by percentage may be changed by changing the amount of the fibers 60 to be added. If the above materials are not dispersed sufficiently, the fibers 60 may flocculate. It is therefore necessary to disperse the materials including the fibers 60 sufficiently. In the case of the outer dielectric layer 41 having a multilayer structure, the fibers 60 may be added near its center in the lamination direction, which may result in a layered distribution of the fibers 60 due to the dispersion of the fibers 60.

When the fibers 60 are present in a layer closer to the first surface 11 or closer to the second surface 12 in the multilayer structure of the outer dielectric layer 41, the fibers 60 can reduce the occurrence of cracks in the multilayer ceramic capacitor 1 when the multilayer ceramic capacitor 1 is mounted using a mounter and the multilayer ceramic capacitor 1 receives an impact from the mounter.

On the other hand, when the fibers 60 are present in a layer closer to the inner electrodes 30 in the multilayer structure of the outer dielectric layer 41, the fibers 60 can reduce the propagation of cracks into the inner electrodes 30 even if cracks are generated at the first surface 11 or at the second surface 12.
In Step 2, a predetermined pattern of the inner electrode 30 is printed onto a dielectric sheet using the electroconductive paste. This produces the dielectric sheet on which the pattern of the inner electrode for the inner-layer portion 53 is printed. For example, a screen printing or a gravure printing is adopted to apply the electroconductive paste for the inner electrode 30 onto the dielectric sheet.
In Step 3, dielectric sheets and other dielectric sheets on which the patterns of the inner electrodes are printed are laminated. The dielectric sheets laminated are pressed in the lamination direction 100 using, for example, an isostatic pressing. A multilayer block is thus produced.
In Step 4, the multilayer block is cut into multilayer chips having a predetermined size. The multilayer chips may be subjected to barrel polishing to round edges and corners thereof.
In Step 5, each multilayer chip is baked to produce the multilayer body 2 of the present example embodiment.
In Step 6, an electroconductive paste including glass and metal components is applied onto the third surface 13 and the fourth surface 14 of the multilayer body 2 using, for example, dipping. The base electrode layer 24 is thereby formed.

As an alternative method of forming the base electrode layer 24, the electroconductive paste is first applied onto the fifth surface 15 and the sixth surface 16 by pressing the electroconductive paste out through slitted plates, and subsequently, the electroconductive paste is further applied onto the third surface 13 and the fourth surface 14 using, for example, dipping. The base electrode layer 24 can be formed also in this manner.
In Step 7, the plating layer 26 is formed so as to connect with the base electrode layer 24. It is preferable to use electrolytic plating for this purpose. It is also preferable to use a barrel plating method.

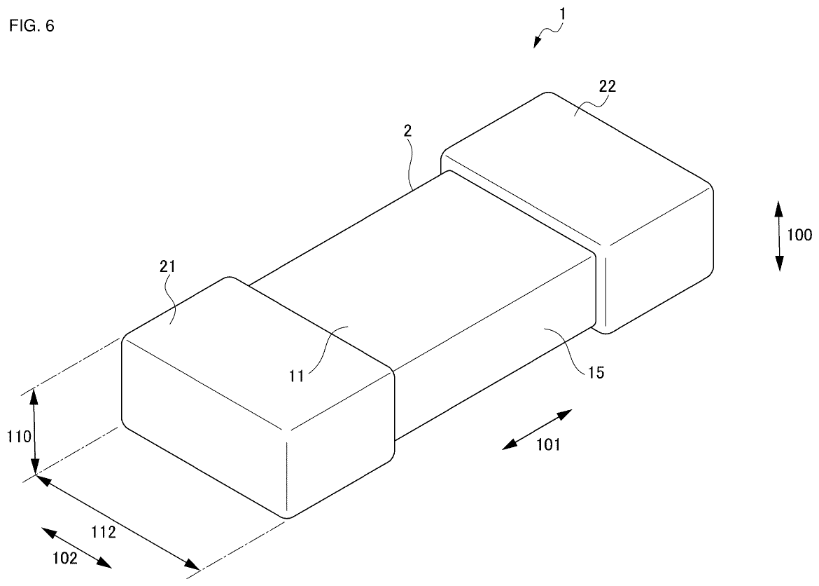

The multilayer ceramic capacitor 1 illustrated in FIGS. 1 and 3 has been described as having the structure in which the length in the lamination direction 100 is equal to the length in the second direction 102. As described above, the multilayer ceramic capacitor 1 of the present example embodiment provides a remarkable effect of improving the strength especially for a so-called “slim product”. FIG. 6 is a view outlining a slim multilayer ceramic capacitor 1. In the multilayer ceramic capacitor 1 illustrated in FIG. 6, the length 110 in the lamination direction 100 is smaller than the length 112 in the second direction 102. The multilayer ceramic capacitor 1 of which the length 110 is smaller than the length 112 is called the “slim multilayer ceramic capacitor”. The slim multilayer ceramic capacitor tends to have an insufficient strength compared with the multilayer ceramic capacitor 1 of which the length 110 and the length 112 are substantially equal as illustrated in FIG. 1. In the multilayer ceramic capacitor 1 of the present example embodiment, however, the multilayer body 2 includes the fibers 60. Accordingly, the strength can be increased even if the multilayer ceramic capacitor 1 is the slim product.

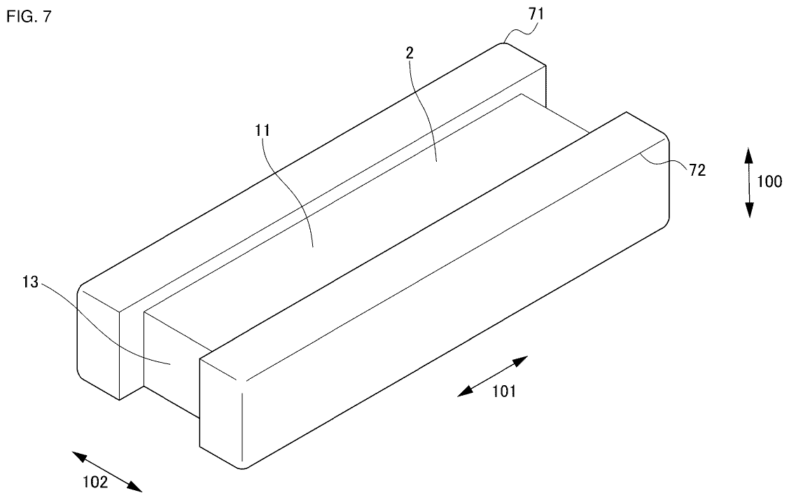

In the present example embodiment, the positions of the outer electrodes 20 can be changed appropriately. As illustrated in FIG. 1, the multilayer ceramic capacitor 1 is described as a two-terminal type product having the structure in which the outer electrodes 20 located at opposite ends in the longitudinal direction. The arrangement of the outer electrodes 20, however, is not limited to this. FIG. 7 is a view outlining a multilayer ceramic capacitor 1 that has the outer electrodes 20 arranged in the transverse direction thereof. In the multilayer ceramic capacitor 1 of FIG. 7, the outer electrodes 20 are positioned at opposite ends thereof in the transverse direction, in other words, on the fifth surface 15 and the sixth surface 16 instead of being positioned at opposite ends in the longitudinal direction, in other words, on the third surface 13 and the fourth surface 14. More specifically, an outer electrode 72 is provided on the fifth surface 15, and an outer electrode 71 is provided on the sixth surface 16. Consequently, according to the multilayer ceramic capacitor 1 of the present example embodiment, the outer electrodes 20 may be arranged in the transverse direction as illustrated in FIG. 7.

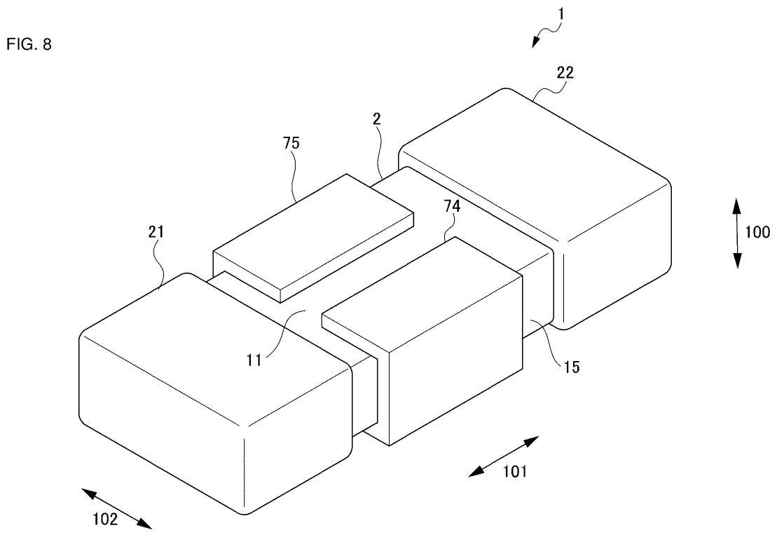

The multilayer ceramic capacitor 1 of the present example embodiment is not limited to the two-terminal type product. FIG. 8 is a view illustrating a three-terminal multilayer ceramic capacitor 1. In addition to the first outer electrode 21 and the second outer electrode 22, the multilayer ceramic capacitor 1 of the present example embodiment may also include an outer electrode 74 and an outer electrode 75 that serve as the third terminal as illustrated in FIG. 8.

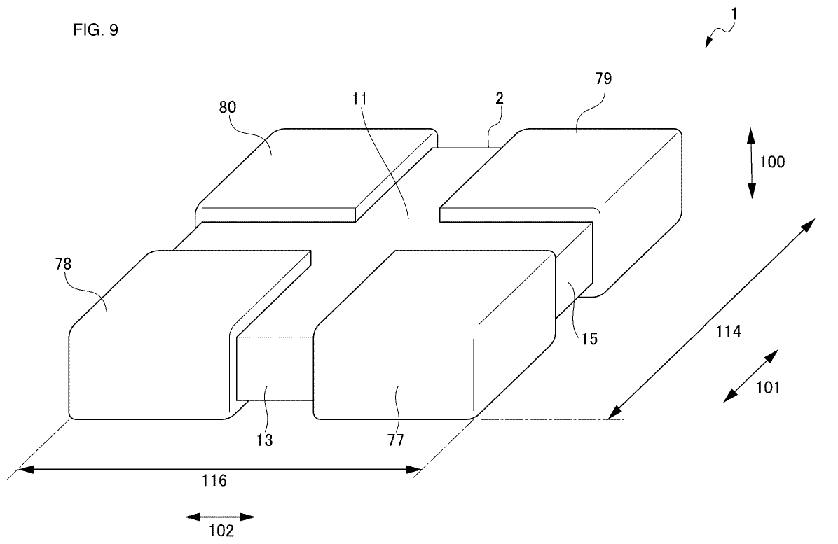

In addition, in the multilayer ceramic capacitor 1 of the present example embodiment, the length in the first direction 101 may be equal to the length in the second direction 102. FIG. 9 is a view outlining a so-called “square multilayer ceramic capacitor 1”. In the multilayer ceramic capacitor 1 illustrated in FIG. 9, the length 114 in the first direction 101 may be equal to the length 116 in the second direction 102. The multilayer ceramic capacitor 1 of which the length 114 in the first direction 101 is equal to the length 116 in the second direction 102 is called the square multilayer ceramic capacitor 1.

The square multilayer ceramic capacitor 1 may include outer electrodes 20 located at four corners of the surface that extends parallel to the first direction 101 and the second direction 102. In the example illustrated in FIG. 9, outer electrodes 77, 78, 79, and 80 are positioned to define and function as the outer electrodes 20.

Example embodiments of the present invention have been described. The present invention, however, is not limited to the above example embodiments and may be subjected to various modifications, alterations, and combinations of elements.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including:
a first surface and a second surface that face oppositely in a lamination direction;
a third surface and a fourth surface that face oppositely in a first direction that orthogonally intersects the lamination direction; and
a fifth surface and a sixth surface that face oppositely in a second direction that orthogonally intersects the lamination direction and the first direction;
a first outer electrode on the third surface of the multilayer body; and
a second outer electrode on the fourth surface of the multilayer body; wherein
the multilayer body includes an inner-layer portion and two outer-layer portions sandwiching the inner-layer portion in the lamination direction;
each of the two outer-layer portions includes an outer dielectric layer; and
the outer dielectric layer includes fibers.

2. The multilayer ceramic capacitor according to claim 1, wherein the fibers are not exposed at any surface of the multilayer body.

3. The multilayer ceramic capacitor according to claim 1, wherein a thickness of an individual fiber is about 1 nm or more and about 1000 nm or less.

4. The multilayer ceramic capacitor according to claim 1, wherein a content of the fibers by percentage is about 1.0 wt % or more and about 30.0 wt % or less.

5. The multilayer ceramic capacitor according to claim 1, wherein a number of intersections of the fibers is five or more in a region of approximately 2.5 μm×2.5 μm in a cross section of the multilayer ceramic capacitor extending in the lamination direction and in the first direction.

6. The multilayer ceramic capacitor according to claim 1, wherein a dimension of the multilayer ceramic capacitor in the lamination direction is about 80 μm or less.

7. The multilayer ceramic capacitor according to claim 1, wherein a dimension of the multilayer ceramic capacitor in the second direction is larger than a dimension of the multilayer ceramic capacitor in the first direction.

8. The multilayer ceramic capacitor according to claim 1, wherein a dimension of the multilayer ceramic capacitor in the second direction is substantially equal to a dimension of the multilayer ceramic capacitor in the first direction.

9. The multilayer ceramic capacitor according to claim 1, further comprising:
a third outer electrode on the fifth surface of the multilayer body; and
a fourth outer electrode on the sixth surface of the multilayer body.

10. The multilayer ceramic capacitor according to claim 1, wherein a dimension of the multilayer ceramic capacitor is about 40 μm or less in the lamination direction.

11. The multilayer ceramic capacitor according to claim 1, wherein the fibers are carbon fibers.

12. The multilayer ceramic capacitor according to claim 1, wherein the fibers are entangled with each other.

13. The multilayer ceramic capacitor according to claim 1, wherein the multilayer body includes a plurality of outer dielectric layers each including the fibers.

14. The multilayer ceramic capacitor according to claim 1, wherein the multilayer body includes a plurality of outer dielectric layers, and at least one of the plurality of outer dielectric layers includes the fibers and is laminated on another of the plurality of outer dielectric layers not including the fibers.

15. The multilayer ceramic capacitor according to claim 1, wherein the multilayer body includes a plurality of outer dielectric layers some including the fibers and others not including the fibers, and the others of the plurality of outer dielectric layers not including the fibers define the first surface and the second surface.

16. The multilayer ceramic capacitor according to claim 1, wherein a length of each of the fibers is about 1 μm or more and about 100 μm or less.

17. The multilayer ceramic capacitor according to claim 1, wherein the fibers are silicon carbon fibers.

18. The multilayer ceramic capacitor according to claim 1, wherein the fibers are alumina fibers.

19. The multilayer ceramic capacitor according to claim 1, wherein the fibers are boron fibers.
